(19) United States
(12) Patent Application Publication
(10) Pub. No.: US 2011/0230288 A1
(43) Pub. Date: Sep. 22, 2011

(54) TENSIONING UNIT FOR A TRACTION-MEANS TENSIONING DEVICE

(75) Inventor: Jurgen Schulz, Nurnberg (DE)

(73) Assignee: SCHAEFFLER TECHNOLOGIES GMBH & CO. KG, Herzogenaurach (DE)

(21) Appl. No.: 13/129,494

(22) PCT Filed: Nov. 3, 2009
(86) PCT No.: PCT/EP2009/064480

§ 371 Date: May 16, 2011

(30) Foreign Application Priority Data
Nov. 27, 2008 (DE) 10 2008 059 191.2

(51) Int. Cl. F16H 7/08

(52) U.S. Cl. 474/110

(57) ABSTRACT

A tensioning unit (10) for a traction-means tensioning device, particularly for a timing-chain tensioning device of an internal combustion engine, is provided. The tensioning unit (10) includes a piston (16), which is movably supported in a housing (12), preferably hydraulically damped, and can be driven out of the housing (12) to tension the traction element. A locking element (30), which is pre-loaded in the direction of the piston (16), locks the piston (16) in one of the tensioning positions thereof. The locking element (30) includes teeth (34), which engage with mating teeth (36) formed on the piston (16) to lock the piston (16). The locking element (30) is produced near-net-shape by powder-metallurgical injection molding.

### FIELD OF THE INVENTION

The invention relates to a tensioning unit for a traction-element tensioning device, in particular, for a timing-chain tensioning device of an internal combustion engine, wherein the tensioning unit has a piston that is mounted so that it can move in a housing, advantageously damped hydraulically, and can be extended out from the housing for tensioning the traction element, and a catch element biased in the direction of the piston for locking the piston in its tensioning positions, wherein the catch element has teeth that engage with mating teeth formed on the piston for locking the piston.

### BACKGROUND

Traction-element tensioning devices could be used, for example, in motor vehicles for biasing traction elements, such as timing chains or timing belts, in internal combustion engines. The necessary biasing force is generated in the traction-element tensioning devices by so-called tensioning units or tensioners. To this end, the tensioning unit has an adjustable piston that is coupled with a stop means that acts directly on the traction element to be tensioned.

For example, due to wear in the different components that are coupled by the traction element, over time this wear could lead to a decrease in the biasing force. For this reason, the tensioning units are often equipped with a readjustment mechanism that automatically readjusts the tensioning unit, in order to guarantee the most constant possible biasing force over the entire operating period. The tensioning unit noted above is here equipped, for example, with a catch element that interacts via teeth with mating teeth formed on the piston.

Because the components of the tensioning unit, especially the piston and the catch element, are always in use when the internal combustion engine is running and are therefore exposed continuously to high loading, the components are designed accordingly to prevent sudden failure of one of the components by all means. Thus, a sudden failure of the tensioning unit would lead to a sudden drop of the traction-element tension, which could have possibly fatal consequences for the functional units controlled by the traction element. For this reason, the components of the tensioning unit, especially the piston and the catch element, are typically machined by cutting processing methods, such as milling, from a solid blank, in order to guarantee sufficient strength, durability, and thus operating reliability of the tensioning unit. A disadvantage here is that the cutting processing methods are time-intensive and also have a very high expense of material due to the machining from a solid blank.

Starting from the prior art named above, the objective of the invention is to improve the tensioning unit named above such that the tensioning unit is easier to produce for a consistently high guarantee of the operating reliability.

### SUMMARY

This objective is met by a tensioning unit with the features according to the invention and especially in that the catch element has been produced close to its final form through powder metallurgical injection molding.

The powder metallurgical injection molding, also called the MIM method (from Metal Injection Molding), has indeed been known for some time. However, it is assumed that due to the special features of this production method, the components produced in this way could have lower strength compared with structurally identical components that have been produced by conventional production methods, such as cutting methods. Surprisingly, however, it has been shown that the components produced by the powder metallurgical injection molding have similarly high strength values, like in components produced conventionally, wherein a production close to the final form is also enabled, without the component to be produced having to be subjected to even more extensive post-processing, for example, due to cutting methods.

For the tensioning unit according to the invention, it has been shown that the catch element is particularly well suited to powder metallurgical injection molding. The catch element produced in this way exhibits similarly high strength values as conventionally produced catch elements, but can be produced with significantly lower expense. In addition, it is possible to provide selective recesses and depressions for weight savings on the catch element also without additional expense.

Additional advantages of the invention are given from the following description, the drawing, and also the subordinate claims.

Thus it is proposed to harden the catch element by heat treatment. It has been shown that the surface hardness, especially in the region of the teeth, of the catch element produced through powder-metallurgical injection molding can be increased selectively through heat treatment, such as induction hardening, in order to minimize wear, especially on sections with high loading, for example, the teeth.

So that the catch element can withstand the maximum loads occurring during operation, the catch element has a degree of hardness of at least 28 HRC (DIN EN ISO 6508-2) in the region of the straight teeth.

With appropriate heat treatment, however, higher degrees of hardness could also be achieved.

As the material, the use of machining steel and quality steels has proven especially suitable. For example, the catch element is produced in an especially preferred way from a machine steel with a carbon content of 0.40 to 0.45, such as 45S20 (material number 1.0717), or an unalloyed quality steel with a carbon content of 0.90 to 0.99, such as D 95-2 (material number 1.0618), as the starting material for the powder metallurgical injection molding. In general, however, other materials could also be used that are usually selected according to performance-specific features, such as strength, ability to be machined, ability to be heat treated, heat treating quality, etc.

In order to save weight and material, in one especially preferred embodiment of the tensioning unit according to the invention, it is further proposed to form recesses for reducing weight adjacent to the teeth on the catch element. The recesses are here structured and arranged on the catch element so that they lie outside of the lines of main tension, so that the resistance moment of the catch element is not negatively affected overall.

### BRIEF DESCRIPTION OF THE DRAWINGS

The invention will be explained in detail below using an embodiment with reference to the enclosed drawing. Shown therein are:

FIG. 1 a sectioned side view of a tensioning unit according to the invention that is used for a timing-chain tensioning device of an internal combustion engine; and

FIG. 2 an enlarged, perspective view of a catch element used in the tensioning unit according to the invention.

### DETAILED DESCRIPTION OF THE PREFERRED EMBODIMENTS

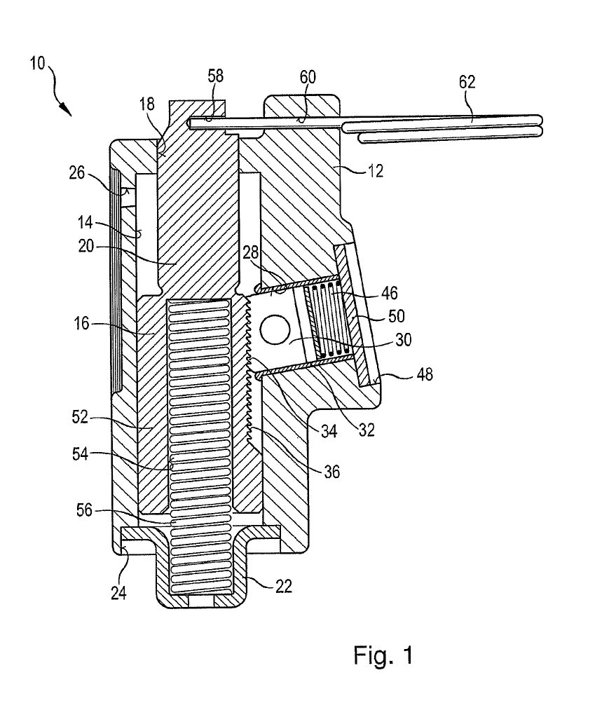

FIG. 1 shows a sectioned side view of a tensioning unit 10 according to the invention, which is used in a tensioning device for the timing chain of an internal combustion engine.

The tensioning unit 10 has a housing 12 in which a receptacle 14 is constructed for receiving a piston 16. On its end shown at the top in FIG. 1, the receptacle 14 has a guide opening 18 through which the piston 16 projects with an adjustment section 20. On its end shown at the bottom in FIG. 1, the receptacle 14 is closed by a closing element 22 that has a cup-shaped cross section and is secured in an extension 24 of the receptacle 14, for example, by welding.

Directly adjacent to the guide opening 18, on the housing 12 there is side channel 26 that is in fluid connection with the receptacle 14. The channel 26 is used for connecting a hydraulic reservoir not shown in detail.

A passage opening 28 that runs at an angle of approximately 85° with respect to the longitudinal direction of the piston 16 and ends in the receptacle 14 is formed on the housing 12 at approximately half the height of the receptacle 14. A catch element 30 is held in the passage opening 28, wherein this catch element has at least approximately a rectangular cross section and is guided so that it can move longitudinally in a socket 32 held in the passage opening 28.

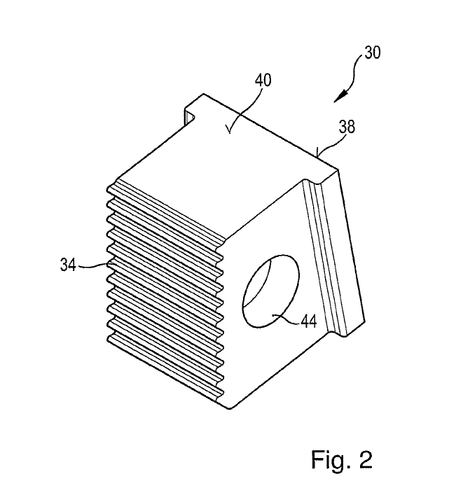

The catch element 30 that is shown enlarged in FIG. 2 in a perspective view has, on its flat side pointing into the receptacle 14, straight teeth 34 that engage with mating teeth 36 formed on the piston 16. Viewed transverse to the longitudinal direction of the straight teeth 34, the catch element 30 likewise has an approximately rectangular cross section that transitions into a stop collar 38. Viewed in the longitudinal direction of the straight teeth 34, the catch element is expanded like a wedge between its two flat sides 40 and 42 running transverse to the straight teeth 34. The degree of opening of the wedge of the catch element 30 here corresponds to the angle of inclination of the passage opening 28, so that, when the catch element 30 is inserted into the socket 32, the straight teeth 34 run at least approximately parallel to the longitudinal direction of the piston 16.

On both side surfaces, the catch element 30 is provided with round pocket holes 44 of which only one is shown in FIGS. 1 and 2, wherein these holes are used for weight savings, without negatively affecting the strength of the catch element 30.

Different from what is typical up until now in the prior art, the catch element 30 is not produced by cutting machining from a solid blank, but has been produced instead by so-called powder-metallurgical injection molding (MIM=Metal Injection Molding). Here, as the material, an unalloyed quality steel with comparatively high carbon content of 0.90 to 0.99 is used. The quality steel with the material number 1.0618 (D 95-2) has been shown to be especially suitable for the production of the catch element 30. The catch element 30 is also heat-treated such that it has a hardness of at least 28 HRC (defined according to DIN EN ISO 6508-2) at least in the region of the straight teeth 34.

The catch element 30 is biased by a compression spring 46 likewise arranged in the passage opening 28 in the direction of the piston 16, wherein the compression spring 46 is supported on a support element 50 mounted in an extension 48 and contacts the stop collar 38 of the catch element 30.

The adjustment section 20 of the piston 16 transitions into a guide section 52 on whose side facing the catch element 30, the mating teeth 36 are formed. Furthermore, in the guide section 52, a receptacle drill hole 54 running in the longitudinal direction of the piston 16 is formed for a tensioning spring 56. The tensioning spring 56 projects out from the receptacle drill hole 54 and is supported on the closing element 22.

Furthermore, on the adjustment section 20 projecting out from the housing 12, there is a drill hole 58 that runs transverse to the longitudinal direction of the piston 16 and in which a securing element 60 is introduced that is placed through a passage drill hole 62 formed in the housing 12 at the same height and in this way secures the piston 16 in an assembled position, as shown in FIG. 1.

The securing element 60 is removed after assembly of the tensioning unit 10, so that the piston 16 moves outward by the force of the tensioning spring 56, in order to bias the timing chain (not shown). As a function of the chain tension, the piston 16 assumes a middle position in which it is secured by the catch element 30. Simultaneously, hydraulic fluid that can flow into and out from the receptacle 14 through the channel 26 damps the oscillating motion of the piston 16 generated during the operation of the internal combustion engine.

If the chain tension decreases, the tensioning spring 56 presses the piston 16 into a new, raised position in which the mating teeth 36 are re-engaged with the straight teeth 34 of the catch element 30, in order to maintain the biasing tension on the timing chain. When the chain tension increases, the piston 16 is pressed back into the receptacle 14 against the force of the tensioning spring 56 and is secured again by the catch element 30 in this lowered position, in order to keep the tensioning effect of the piston 16 as constant as possible.

As the described function shows, the catch element 30, especially the straight teeth 34, must withstand relatively high mechanical loading. Despite the mechanical loading that appears, tests have shown that the catch element 30 according to the invention produced by powder metallurgical injection molding can withstand the generated loading without a problem. Through the powder metallurgical injection molding of the catch element 30, the production of the catch element 30 is significantly simplified relative to previous production methods, because a formation of the catch element 30 close to the final shape is already possible. In addition, it is possible to save weight and thus material, which is a bigger advantage for mass-produced products, such as the tensioning unit according to the invention.

### Reference Symbols

10 Tensioning unit

12 Housing

14 Receptacle

16 Piston

18 Guide opening

20 Adjustment section

22 Closing element

24 Extension

26 Channel

28 Passage opening

30 Catch element

32 Socket

34 Straight teeth

36 Mating teeth

38 Stop collar

40 Flat side

42 Flat side

44 Pocket holes

46 Compression spring

48 Extension

50 Support element

52 Guide section

54 Receptacle drill hole

56 Tensioning spring

58 Drill hole

60 Safety element

62 Passage drill hole

1. Tensioning unit for a traction-element tensioning device, wherein the tensioning unit comprises a piston that is mounted so that the piston can move in a housing and can be extended out from the housing for tensioning the traction element, a catch element biased in a direction of the piston for locking the piston in tensioning positions, wherein the catch element has teeth that engage with mating teeth formed on the piston for locking the piston, and the catch element is a powder-metallurgical injection molded part formed close to a final form.

2. Tensioning unit according to claim 1, wherein the catch element is hardened by heat treatment.

3. Tensioning unit according to claim 1, wherein the catch element has a hardness of at least 28 HRC (DIN EN ISO 6508-2) at least in a region of the teeth.

4. Tensioning unit according to claim 1, wherein the catch element is produced from a machining steel with a carbon content of 0.40 to 0.45 or an unalloyed quality steel with a carbon content of 0.90 to 0.99 as a starting material.

5. Tensioning unit according to claim 1, wherein recesses for reducing weight are located adjacent to the teeth on the catch element.
